(19) United States
(12) Patent Application Publication
(10) Pub. No.: US 2025/0248422 A1
(43) Pub. Date: Aug. 7, 2025

(54) EMULSION COMPRISING VITAMIN D OR ITS DERIVATIVES HAVING IMPROVED STABILITY

(71) Applicant: SOCIETE DES PRODUITS NESTLE S.A., Vevey (CH)

(72) Inventors: LAURENT SAGALOWICZ, Blonay (CH); ERIC GABRIEL MARCHAL, Vittel (FR); PATRICIA ROSSI VAUTHEY, Chatel-St-Denis (CH); FEDERICO ROTA, Lausanne (CH); LYDIE VOCANSON, Saint-sauveur-de-montagut (FR); CECILE LAURENT, Girmont (FR); JOHANN BUCZKOWSKI, Corcelles-le-Jorat (CH)

(21) Appl. No.: 18/855,882

(22) PCT Filed: Apr. 4, 2023
(86) PCT No.: PCT/EP2023/058837

§ 371 Date: Oct. 10, 2024

(30) Foreign Application Priority Data
Apr. 12, 2022 (EP) 22168012.7

(51) Int. Cl. A23L 2/52; A23D 7/005; A23D 7/01; A23D 9/013

(52) U.S. Cl. CPC A23L 2/52; A23D 7/0053; A23D 7/011; A23D 9/013

(57) ABSTRACT

The present invention relates to an emulsion comprising vitamin D or its derivatives, a stabilizer preferably a hydrocolloid and a triglyceride and to a beverage comprising said emulsion. The present invention also relates to a process for obtaining such emulsion and the use thereof.

### FIELD OF THE INVENTION

The present invention relates to an emulsion comprising vitamin D or its derivatives, a stabilizer preferably a hydrocolloid, and a triglyceride and to a beverage comprising said emulsion. The present invention also relates to a process for obtaining such emulsion and the use thereof.

### BACKGROUND AND PRIOR ART

Vitamin D is a micronutrient, having a crucial role in calcium homeostasis, bone metabolism and immunity. Vitamin D may be naturally present in food, added to food and may be also available as a dietary supplement. Vitamin D may also be produced endogenously when ultraviolet (UV) rays from sunlight strike the skin and trigger vitamin D synthesis. Vitamin D mainly exists under two forms, namely vitamin D2 (ergocalciferol), which is synthetized by plants and vitamin D3 (cholecalciferol), which is synthetized in the human skin by an exposure to sunlight (UVB irradiation).

Recent studies highlight the importance of vitamin D in the prevention of cancer, cardiovascular diseases, diabetes, immunological and neurological disorders. In particular, it has been discovered that Vitamin D is involved in immune function and has significant effects on immune cells. Vitamin D also plays a crucial role in calcium and phosphorus metabolism.

Vitamin D deficiency is a global public health issue. Vitamin D insufficiency affects almost 50% of the population worldwide. An estimated 1 billion people worldwide, across all ethnicities and age groups, in both developed and developing countries, have a vitamin D deficiency. The prevalence of patients with vitamin D deficiency is highest in the elderly, obese patients, nursing home residents, and hospitalized patients.

Vitamin D deficiency can lead to a loss of bone density, which can contribute to osteoporosis and fractures (broken bones) but also to other diseases such cardiovascular diseases or cognitive impairments in older adults. In children, symptoms of vitamin D deficiency may be irritability, lethargy, developmental delay, bone changes, and/or fractures.

Guidelines from the National Institute of Health increased the recommended dietary allowance (RDA) of vitamin D to 600 international units (IU) for everyone ages 1-70, and raised it to 800 IU for adults older than age 70 to optimize bone health. The safe upper limit was also raised to 4,000 IU (1 IU of Vitamin D=0.025 μg of Vitamin D) for adults according to the guidelines from the National Institute of Health.

Treatment for vitamin D deficiency involves getting more vitamin D, through dietary and supplements.

Nowadays, there is growing interest in fortifying emulsions with Vitamin D to improve human health and wellness. Fortification of an emulsion is an effective way to supplement vitamin D. However, during processing and storage, different factors such as pH, light, oxygen and temperature may be responsible of chemical degradation of vitamin D and thus may conduct to a loss of its activity. As a lipophilic compound, its introduction, in particular, in a beverage, such as a fortified beverage, requires the formation of a stable emulsion to prevent its degradation for example due to physical mechanisms, such as coalescence, which may disorganize the emulsion and let vitamin D be subjected to chemical degradation.

However, the lipophilic properties and stability issues of Vitamin D make its introduction in an emulsion a real challenge. Furthermore, vitamin D is lipophilic and needs to be dispersed in water, which may become an issue. The challenge is thus also to preserve the stability of the emulsion in diluted form without adding additional additives in water phase, which may be associated with costs and off-flavor issues.

There is thus a need to provide emulsions comprising the correct dose of vitamin D (thereby avoiding an excessive amount or a non-significant amount thereof) while being sufficiently stable to ensure that Vitamin D be preserved during processing, storage and/or transportation.

### SUMMARY OF THE INVENTION

A first object of the present invention relates to an emulsion comprising:
between 0,0000002% and 0.1% by weight, preferably between 0,000002% and 0.01%, more preferably between 0,00001% and 0.001% by weight, and even more preferably between 0,0001% and 0.001% by weight, of vitamin D or its derivatives with respect to the total weight of emulsion,
between 0,0001% and 10% by weight, preferably between 0.001% and 5% by weight, more preferably between 0.05% and 1% by weight, and even more preferably between 0.1% and 0.6% by weight, of triglyceride with respect to the total weight of emulsion, and
between 0.01% to 50% by weight, preferably between 0.1% and 50% by weight, preferably between 0.5% and 25% by weight, preferably between 0.75% and 20% by weight, more preferably between 1% and 10% by weight, and even more preferably between 1,5% and 8% by weight, of stabilizer and preferably of hydrocolloid with respect to the total weight of emulsion.

A second object of the present invention relates to a beverage comprising the emulsion as previously defined.

A third object of the present invention relates to a process for preparing the emulsion as previously defined comprising:
a step of mixing triglyceride and vitamin D or its derivatives, optionally monoglyceride or its derivatives and optionally oat oil or oat oil fraction rich in polar lipid, thereby providing a fat phase,
a step of dispersing the stabilizer preferably the hydrocolloid in water, thereby providing a stabilizer dispersion preferably a hydrocolloid dispersion, and
a step of mixing the fat phase and stabilizer dispersion preferably hydrocolloid dispersion, thereby providing a mixture of fat phase and stabilizer dispersion preferably hydrocolloid dispersion.

A fourth object of the present invention relates to the use of the beverage comprising said emulsion as previously defined, as a functional beverage.

### DETAILED DESCRIPTION

In the following description and claims, unless otherwise specified, the ranges of values shown are inclusive. The words “comprises”, “comprising”, and similar words, should not be interpreted in an exclusive or exhaustive sense. In other words, they are intended to mean “including, but not limited to”.

A first object of the present invention relates to an emulsion comprising:
between 0,0000002% and 0.1% by weight, preferably between 0,000002% and 0.01%, more preferably between 0,00001% and 0.001% by weight, and even more preferably between 0,0001% and 0.001% by weight, of vitamin D or its derivatives with respect to the total weight of emulsion,
between 0,0001% and 10% by weight, preferably between 0.001% and 5% by weight, more preferably between 0.05% and 1% by weight, and even more preferably between 0.1% and 0.6% by weight, of triglyceride with respect to the total weight of emulsion, and
between 0.01% to 50% by weight, preferably between 0.1% and 50% by weight, preferably between 0.5% and 25%, preferably between 0.75% and 20%, more preferably between 1% and 10% by weight, and even more preferably between 1,5% and 8% by weight, of stabilizer and preferably of hydrocolloid with respect to the total weight of emulsion.

Preferably, the emulsion further comprises water.

Preferably, the amount of water is comprised between 40% and 99,9% by weight, preferably between 70% and 99,9% by weight, more preferably between 80% and 99,9% by weight, more preferably between 89% and 99,5% by weight, more preferably between 90% and 99,2% by weight, more preferably between 94% and 99% by weight, and even more preferably between 96% and 98% with respect to the total weight of the emulsion.

By “vitamin D or its derivatives” also referred to as “calciferol”, it is herein preferably understood a group of fat-soluble secosteroids.

Examples of vitamin D include, but are not limited to, vitamin D1, vitamin D2, vitamin D3, vitamin D4, vitamin D5, and mixtures thereof.

Examples of derivatives of vitamin D include, but are not limited to, any vitamin D analogs, such as alfacalcidol, calcitriol, paricalcitol, dihydrotachysterol, and mixtures thereof.

Preferably, the vitamin D is under oil form.

By “triglyceride” it is herein preferably understood an ester formed from glycerol and three fatty acid groups. Triglycerides are the main constituents of most fats and oils.

Advantageously, the triglyceride constitutes the oil phase of the emulsion.

Triglyceride is made of three fatty acids having an aliphatic tail of preferably 4-26 carbon atoms, preferably 6-20 carbons.

Source of triglyceride is taken from coconut oil, corn oil, cottonseed oil, olive oil, palm oil, peanut oil, rapeseed oil, safflower oil, sesame oil, soybean oil, sunflower oil, almond oil, Brazil nut oil, cashew nut oil, hazelnut oil, macadamia oil, pecan oil, pine nut oil, pistachio oil, walnut oil, pumpkin seed oil, egusi seed oil, pumpkin seed oil, watermelon seed oil, amaranth oil, apricot oil, apple seed oil, avocado oil, cocoa butter, coriander oil, flaxseed oil, grape seed oil, hemp oil, chia oil, quinoa oil, rice bran oil, wheat bran oil, shea butter, sacha inchi oil, tigernut oil, tomato seed oil, wheat oil and mixture thereof.

Preferably, the triglyceride is a medium chain triglyceride.

By “medium chain triglyceride” or “MCT” it is herein preferably understood triglyceride with two fatty acids having an aliphatic tail of 6-12 carbon atoms, preferably 6-10 carbon atoms and more preferably 8-10 carbon atoms, i.e. a medium-chain fatty acids.

Examples of fatty acids comprise, but are not limited to, caproic fatty acid, caprylic fatty acid, capric fatty acid, lauric fatty acid, and mixtures thereof.

The medium chain triglycerides may be found, for example, in coconut oil, palm kernel oil, palm oil, soybean oil, sunflower oil, rapeseed oil, or mixtures thereof.

By “stabilizer” it is herein preferably understood hydrocolloids, gelatin, proteins such as milk proteins (e.g. whey protein isolate and caseinate), egg proteins and plant-based proteins, low molecular weight surfactants such as polysorbates, phospholipids such as lecithin, lysophospholipids such as lysolecithins, galactolipids, sugar esters, and mixtures thereof, preferably hydrocolloids.

By “hydrocolloid” it is herein preferably understood any water-soluble polymers that contribute viscosity of an emulsion or a solution. Examples of hydrocolloid include, but are not limited to, proteins including milk proteins such as caseinate and B-lactoglobulin, egg proteins, gelatin, vegetable-derived protein isolates such as soy and wheat protein isolates, saponins such as saponin from Quillaja saponaria, and polysaccharides.

Preferably, the hydrocolloid is selected from the group consisting of polysaccharides such as acacia gum, xanthan gum, gelatin, carrageenan gum, gellan gum, karaya gum, larch gum, dextran, chitosan, alginate, hyaluronic acid, guar gum, pectin, cellulose, tara gum, tamarind gum, ghatti gum, curdlan gum, konjac glucomannan, scleroglucan, pullulan, agar, tragacanth gum, Portulaca oleracea gum, galactomannan, pectin, starch or modified starch, cellulose derivative such as caboxymethylcellulose, and furcelleran, and mixtures thereof. More preferably, the hydrocolloid is selected from pectin, acacia gum, guar gum, modified starch, and mixtures thereof.

By “acacia gum” it is herein preferably understood a gum selected from acacia Senegal gum, acacia Seyal gum, acacia Senegalia laeta gum, acacia Senegalia mellifera gum, acacia Senegalia gourmaensis gum, acacia Sterculia setigera gum, acacia Eficacia™ gum, and mixtures thereof.

By “pectin” it is herein preferably understood any pectin such as beet pectin, citrus pectin and/or amidated pectin.

Advantageously, stabilizers preferably hydrocolloids act as emulsifiers by stabilizing physically the emulsion and protecting lipophilic functional compounds, and in particular vitamin D, encapsulated in oil droplets. Thus, these molecules may be capable of adsorbing at the interface oil/water, may form a protective layer around the oil droplets and may prevent the aggregation phenomenon.

The stabilizer content preferably the hydrocolloid content may have an impact on the average oil droplet size and thus on emulsion stability. In particular, the average oil droplet size may decrease when the content of stabilizer preferably of hydrocolloid increases.

The present inventors have surprisingly found that stabilizer preferably hydrocolloid and triglyceride enable to physically and chemically stabilize the emulsion while protecting Vitamin D during a prolonged period (shelf life).

In particular, the inventors have surprisingly found that when the emulsion comprises between 0.0001% and 10% by weight of triglyceride with respect to the total weight of emulsion, and between 0.01% to 50% by weight, preferably between 0.1% and 50% by weight of stabilizer preferably of hydrocolloid with respect to the total weight of emulsion, the emulsion is physically stable, there is no oil droplets aggregation and no creaming, and more important there is no or low chemical degradation of vitamin D such as oxidation, during shelf life.

When the stabilizer content preferably the hydrocolloid content is too high, the emulsion is too high in calories since most hydrocolloids (which are stabilizers) are polysaccharides and also contain sugar. In the same manner, when the triglyceride content is superior to 10% by weight with respect to the total weight of emulsion, the emulsion is too high in calories.

By contrast, when the stabilizer content preferably the hydrocolloid content is inferior to 0.01% by weight and/or when the triglyceride content is inferior to 0.0001% by weight with respect to the total weight of emulsion, the emulsion is not sufficiently stable and vitamin D is not sufficiently protected from degradation. In particular, when the triglyceride content is too low, vitamin D is subjected to chemical degradation and when the stabilizer content preferably the hydrocolloid content is too low, the emulsion is physically unstable.

The emulsion may further comprise between 0.005% and 4% by weight, preferably between 0.01% and 2% by weight, and more preferably between 0.05% and 1% by weight of oat oil or oat oil fraction rich in polar lipid with respect to the total weight of emulsion.

By “oat oil fraction rich in polar lipid”, it is herein preferably understood an oat oil fraction comprising polar lipids.

By “polar lipid”, it is herein preferably understood any amphiphilic lipids with a hydrophilic head and a hydrophobic tail. Examples of polar lipid include, but are not limited to phospholipids, galactolipids, and mixtures thereof.

Preferably, the oat oil fraction comprising polar lipids is an oat oil fraction comprising phospholipids and/or galactolipids, and more preferably an oat oil fraction comprising more than 10% by weight, preferably more than 25% by weight and more preferably more than 35% by weight of phospholipids and/or galactolipids with respect to the total weight of oat oil fraction.

The emulsion may further comprise a monoglyceride or its derivatives.

By “monoglyceride” also referred to as “monoacylglycerol”, it is herein preferably understood compounds composed of a molecule of glycerol linked to a fatty acid via an ester bond.

Preferably, the monoglyceride is composed of a molecule of glycerol linked to a Ce to C20 fatty acid.

The monoglyceride may be found, for example, in olive oil, seed oils such as cottonseed oil, sunflower oil and rapeseed oil.

Preferably, the monoglyceride is unsaturated. More preferably, the monoglyceride is unsaturated and contains less than 30% of saturated fatty acids.

Preferably, the monoglyceride is composed of a molecule of glycerol linked to a fatty acid via an ester bond, preferably of a molecule of glycerol linked to oleic acid or linoleic acid via an ester bond.

Preferably, the fatty acid is composed of more than 50% of oleic acid or linoleic acid.

Derivatives of monoglyceride include, but are not limited to, acetylated monoglycerides (ACETEM), lactylated monoglycerides (LACTEM), diacetyl tartaric acid monoglycerides (DATEM) and citric acid esters of monoglycerides (CITREM).

Advantageously, the monoglycerides or its derivatives may act as emulsifiers and may help to decrease oil droplet size.

Without to be bound by any theory, the present inventors have found that, in an oil-in-water emulsion, vitamin D, which is lipophilic but contains an hydroxyl group, may be located in the interface between oil droplets and water where all oxidation reactions may take place and where it is likely that vitamin D may degrade very fast. The present inventors have surprisingly found that the presence of monoglyceride or its derivatives may be able to create a polar structure (reversed micelles) inside the oil droplets, which may enable the vitamin D to be located in the interior of droplets, far from the interface and thus to be more protected from chemical degradation.

The present inventors surprisingly found that the use of monoglyceride was advantageous, whereas monoglyceride is known to destabilize emulsions in some cases, and is prone to oxidation.

The emulsion may comprise between 0,0001% and 3% by weight, preferably between 0.001% and 1% by weight, more preferably between 0.01% and 0.8% by weight and even more preferably between 0.05% and 0.8% by weight of monoglyceride or its derivatives with respect to the total weight of emulsion.

A small content of monoglyceride or its derivatives may be sufficient to help to decrease droplet oil size. By contrast, a high content of monoglyceride or its derivatives may cause problem of processing because of the ability of the monoglyceride or its derivatives to crystallize and to form viscous lyotropic liquid phases.

When the emulsion contains monoglyceride or its derivatives, a content of monoglyceride or its derivatives comprised between 0.0001% and 3% by weight with respect to the total weight of emulsion may help to decrease oil droplets size and therefore may help to provide a stable emulsion by decreasing aggregation phenomenon. By contrast, when the emulsion contains monoglyceride or its derivatives, a content of monoglyceride or its derivatives superior to 3% by weight with respect to the total weight of emulsion may cause aggregation phenomenon due to the ability of monoglyceride or its derivatives to crystallize and to form viscous lyotropic liquid phases.

The amount of triglyceride and optionally monoglyceride or its derivatives and/or optionally oat oil or oat oil fraction rich in polar lipid may constitute the lipid content. The present inventors have found that when the emulsion comprises triglyceride and optionally monoglyceride or its derivatives and/or optionally oat oil or oat oil fraction rich in polar lipid in the amount as previously disclosed, the emulsion as disclosed is stable and vitamin D is protected from degradation.

Preferably, the ratio between the total amount of hydrocolloid and the total amount of vitamin D or its derivatives in the emulsion (hydrocolloid/vitamin D) is comprised between 5 and 1 000 000, preferably between 50 and 1 000 000, preferably between 200 and 200 000, more preferably between 1 000 and 100 000, and even more preferably 5 000 and 50 000.

Preferably, the ratio between total amount of triglyceride and optionally oat oil or oat oil fraction rich in polar lipid and the total amount vitamin D or its derivatives in the emulsion (triglyceride and optionally oat oil or oat oil fraction rich in polar lipid/vitamin D) is comprised between 150 and 100 000, preferably between 500 and 30 000, more preferably between 900 and 10 000 and, and even more preferably between 1 000 and 5 000.

Preferably, the ratio between the total amount of triglyceride and optionally oat oil or oat oil fraction rich in polar lipid and monoglyceride or its derivatives and the total amount of vitamin D or its derivatives in the emulsion ((triglyceride and optionally oat oil or oat oil fraction rich in polar lipid and monoglyceride or its derivatives)/vitamin D) is comprised between 150 and 100 000, preferably between 500 and 30 000, more preferably between 900 and 10 000, and even more preferably between 1 000 and 5 000.

Preferably, the ratio between the total amount of hydrocolloid and the total amount of triglyceride and optionally oat oil or oat oil fraction rich in polar lipid in the emulsion (hydrocolloid/triglyceride and optionally oat oil or oat oil fraction rich in polar lipid) is comprised between 1 and 100, preferably between 2 and 50, and more preferably between 4 and 15.

Preferably, the ratio between the total amount of hydrocolloid and the total amount of triglyceride and optionally oat oil or oat oil fraction rich in polar lipid and monoglyceride or its derivatives in the emulsion (hydrocolloid/(triglyceride and optionally oat oil or oat oil fraction rich in polar lipid and monoglyceride or its derivatives)) is comprised between 1 and 100, preferably between 2 and 20, and more preferably between 3 and 10.

Preferably, the ratio between the total amount of triglyceride and optionally oat oil or oat oil fraction rich in polar lipid and the total amount of monoglyceride or its derivatives in the emulsion (triglyceride and optionally oat oil or oat oil fraction rich in polar lipid/monoglyceride or its derivatives) is comprised between 0.5 and 100, preferably between 0.8 and 10, and more preferably between 1 and 5.

The present inventors have surprisingly found that the ratios as disclosed enable to obtain an emulsion with an optimized average oil droplet size and therefore a stable emulsion with low calory intake.

The emulsion may further comprise a monosaccharide, a disaccharide, or mixtures thereof.

Examples of monosaccharide and disaccharide include, but are not limited to, fructose, glucose, galactose, sucrose, lactose, maltose, and mixtures thereof.

The monosaccharide and disaccharide may be used to increase density and viscosity of the emulsion.

The monosaccharide and/or disaccharide may be present in a concentration ranging from 0% to 70% by weight, preferably from 0.01% to 65% by weight, and more preferably from 0.1% to 55% by weight with respect to the total weight of the emulsion.

The emulsion may further comprise an acid.

The acid may be selected from the group consisting of citric acid, malic acid, lactic acid, tartaric acid, phosphoric acid, ascorbic acid, and mixtures thereof.

The acid may be present in a concentration ranging from 0% to 0.5% by weight, preferably from 0.02% to 0.5% by weight, more preferably from 0.05% to 0.4% by weight and even more preferably from 0.1% to 0.3% by weight with respect to the total weight of the emulsion.

The acid as previously defined may act as antioxidant.

The emulsion may further comprise an antioxidant other than the acid as previously defined, preferably selected from the group consisting of tocopherol and its derivatives such as DL-α-tocopherol, ascorbic acid and its derivatives such ascorbic palmitate, synthetic antioxidants, such as butylated hydroxytoluene, butyl hydroxyanisole and tertiary butyl hydroquinone, vegetable extracts such as rosemary and green tea, phenolic acids such as caffeic, quinic and chlorogenic acids, caffeine, amino acids, phenyl indanes and sequestering agents, for example citrates and ethylenediaminetetraacetic acid (EDTA), and mixtures thereof.

The antioxidant other than the acid may be present in a concentration comprised between 0% and 0.1% by weight, preferably between 0.00000002% and 0.1% by weight, preferably between 0.000001% and 0.01% by weight, more preferably between 0.000002% and 0.001% by weight, and even more preferably between 0.00001% and 0.001% by weight with respect to the total weight of the emulsion.

Preferably, the emulsion as defined in the present invention comprises:
between 0.0000002% and 0.1% by weight, preferably between 0.000002% and 0.01%, more preferably between 0.00001% and 0.001% by weight, and even more preferably between 0.0001% and 0.001% by weight, of vitamin D or its derivatives with respect to the total weight of emulsion,
between 0.0001% and 10% by weight, preferably between 0.001% and 5% by weight, more preferably between 0.05% and 1% by weight, and even more preferably between 0.1% and 0.6% by weight, of triglyceride with respect to the total weight of emulsion,
between 0.01% to 50% by weight, preferably 0.1% and 50% by weight, preferably between 0.5% and 25%, preferably between 0.75% and 20%, more preferably between 1% and 10% by weight, and even more preferably between 1.5% and 8% by weight, of stabilizer and preferably of hydrocolloid with respect to the total weight of emulsion,
between 40% and 99.9% by weight, preferably between 70% and 99.9% by weight, more preferably between 80% and 99.9% by weight, more preferably between 89% and 99.5% by weight, more preferably between 90% and 99,2% by weight, more preferably between 94% and 99% by weight, and even more preferably between 96% and 98% of water with respect to the total weight of the emulsion,
optionally between 0.005% and 4% by weight, preferably between 0.01% and 2% by weight, and more preferably between 0.05% and 1% by weight of oat oil or oat oil fraction rich in polar lipid with respect to the total weight of emulsion,
optionally between 0.0001% and 3% by weight, preferably between 0.001% and 1% by weight, more preferably between 0.01% and 0.8% by weight and even more preferably between 0.05% and 0.8% by weight of monoglyceride or its derivatives with respect to the total weight of emulsion,
optionally between from 0% to 0.5% by weight, preferably from 0.02% to 0.5% by weight, more preferably from 0.05% to 0.4% by weight and even more preferably from 0.1% to 0.3% by weight of acid such as citric acid with respect to the total weight of the emulsion,
optionally between from 0% to 70% by weight, preferably from 0.01% to 65% by weight, and more preferably from 0.1% to 55% by weight of monosaccharide and/or disaccharide with respect to the total weight of the emulsion.

Preferably, the emulsion is an oil-in-water emulsion. In particular, the emulsion may comprise dispersed oil droplets.

The average oil droplet size may be in the range comprised between 50 nm and 3 000 nm, preferably between 100 nm and 1 000 nm, more preferably between 150 nm and 500 nm, and even more preferably between 200 nm and 300 nm.

The average oil droplet size may have an impact on the stability of the emulsion. In particular, high average oil droplet size, may require high shear during the mixing step, can lead to the agglomeration and creaming of the emulsion and may trigger the vitamin D degradation.

Stabilizer preferably hydrocolloid and optionally monoglyceride or its derivatives may have an impact on the average oil droplet size.

By “average oil droplet size” it is preferably understood the average diameter of oil droplets, more preferably the average hydrodynamic diameter (Dh) as weighted by volume of the oil droplets.

The hydrodynamic diameter (Dh) of a molecule may be defined as the diameter of a perfect solid sphere that would exhibit the same hydrodynamic friction as the molecule of interest. Thus, the Dh value reflects primarily the hydrodynamic friction but is usually also a good estimation of the absolute size of the molecule especially in the case of oil droplets. Those are typically determined using light scattering experiments.

The average oil droplet size may be measured by any methods well-known for the skilled person.

Preferably, the average oil droplet size is measured by Static Light Scattering (SLS), Dynamic Light Scattering (DLS) or optical microscopy and more preferably by Dynamic Light Scattering (DLS).

The average oil droplet size and in particular the hydrodynamic diameter (Dh) of the oil droplets is a key parameter to analyze the aggregation phenomenon, which leads to unstable emulsion.

Aggregation, coalescence, flocculation and creaming may characterize instability of an emulsion.

The emulsion stability may be determined by any well-known methods for the skilled person such as viscosity analysis, turbidity analysis, microscopy analysis, measurement of average oil particle size such as by Dynamic Light Scattering (DLS) and Zeta Potential Analysis.

Indicators of emulsion instability may be:
a loss of turbidity,
agglomeration between droplets,
changes in the oil droplet size,
a decrease of zeta potential value,
changes in viscosity.

Preferably, according to the present invention the emulsion is considered as being stable if:
the average oil droplet size is comprised between 50 nm and 3 000 nm, preferably between 100 nm and 1 000 nm, more preferably between 150 nm and 500 nm, and even more preferably between 200 nm and 300 nm, and
the loss of vitamin D is weak.

Advantageously, the emulsion as previously defined has a shelf life of at least 1 month, preferably of at least 6 months, more preferably of at least 12 months, more preferably of at least 18 months and even more preferably of at least 24 months.

By “shelf life” it is herein preferably understood the period during which the emulsion retains acceptable physicochemical properties from a safety and organoleptic properties point of view.

The shelf life can be measured at a temperature ranging from 20° C. to 60° C. during a period from 2 weeks to 24 months. Preferably, extended shelf life is measured at 20° C. to 30° C. during 6 months to 24 months and accelerated shelf life is measured at 35° C. to 60° C. during 2 weeks to 6 months.

A second object of the present invention relates to a beverage comprising the emulsion as previously defined.

By “beverage” it is herein preferably understood any liquid suitable for drinking, including for example water, soda, tea, coffee, milk and/or juice. Preferably, the beverage is water.

The beverage of the invention comprises advantageously between 0.01 and 3% by weight of the emulsion as previously defined, with respect to the total weight of beverage, more preferably between 0.02 and 2.5%.

A third object of the present invention concerns a process for preparing an emulsion with the following steps:
a step of mixing triglyceride and vitamin D or its derivatives, optionally monoglyceride or its derivatives and optionally oat oil or oat oil fraction rich in polar lipid, thereby providing a fat phase,
a step of dispersing the stabilizer preferably the hydrocolloid in water, thereby providing a stabilizer dispersion preferably a hydrocolloid dispersion, and
a step of mixing the fat phase and stabilizer dispersion preferably hydrocolloid dispersion, thereby providing a mixture of fat phase and stabilizer dispersion preferably hydrocolloid dispersion.

Preferably, the step of dispersing the stabilizer preferably the hydrocolloid in water comprises the solubilization of the stabilizer preferably the hydrocolloid in water.

The process may further comprise a step of diluting in water the mixture of fat phase and stabilizer dispersion preferably hydrocolloid dispersion, thereby providing a beverage.

Thus, the present invention also relates to a process for preparing a beverage, wherein said process comprises the following steps:
a step of mixing triglyceride and vitamin D or its derivatives, optionally monoglyceride or its derivatives and optionally oat oil or oat oil fraction rich in polar lipid, thereby providing a fat phase,
a step of dispersing the stabilizer preferably the hydrocolloid in water, thereby providing a stabilizer dispersion preferably a hydrocolloid dispersion,
a step of mixing the fat phase and stabilizer dispersion preferably hydrocolloid dispersion, thereby providing a mixture of fat phase and stabilizer dispersion preferably hydrocolloid dispersion, and
a step of diluting the mixture of fat phase and stabilizer dispersion preferably hydrocolloid dispersion to obtain a beverage.

The step of mixing the fat phase and stabilizer dispersion preferably hydrocolloid dispersion may be selected from dispersion, sonication such as ultrasonification, homogenization such as valve homogenization, high speed mixing, high shear mixing, mixing with rotor stator apparatus, mechanical agitation, extrusion, microfluidization, and combination thereof.

Preferably, the step of mixing the fat phase and stabilizer dispersion preferably hydrocolloid dispersion is performed using valve homogeneization with at least one step at a pressure comprised between 40 bars to 1 500 bars, preferably between 80 bars and 1 000 bars, and more preferably between 150 bars and 350 bars. The pressure used during the mixing step may have an impact on the average oil droplet size and thus on the emulsion stability by decreasing the average oil droplet size. In particular, higher pressure is, the smaller the hydrodynamic diameter may be.

Advantageously, a pressure comprised between 40 bars to 1 500 bars enables to ensure a droplet size comprised between 50 nm and 3 000 nm, and thus to obtain a stable emulsion. Below 40 bars, the average oil droplet size may be not sufficiently reduced. Above 1500 bars, the step of mixing may be not achievable at industrialization scale.

Preferably, the step of mixing the fat phase and stabilizer dispersion preferably hydrocolloid dispersion is a dispersion step and/or high shear mixing of fat phase in water followed by a homogenization step. The dispersion may be performed with a rotor/stator. The homogenization may be performed with a valve homogenizer.

An acid as previously defined may be added after the step of mixing the fat phase and stabilizer dispersion preferably hydrocolloid dispersion.

A monosaccharide, a disaccharide, or mixtures thereof, as previously defined may be added after the step of mixing the fat phase and stabilizer dispersion preferably hydrocolloid dispersion.

The step of mixing triglyceride and vitamin D or its derivatives and optionally monoglyceride or its derivatives and optionally oat oil or oat oil fraction rich in polar lipid, and the step of mixing the fat phase and stabilizer dispersion preferably hydrocolloid dispersion may be performed at a temperature comprised between 20° C. and 110° C., preferably at a temperature comprised between 35° C. and 85° C. and more preferably at a temperature comprised between 50° C. and 70° C.

The process may further comprise at least one step of pasteurizing the mixture of fat phase and stabilizer dispersion preferably hydrocolloid dispersion.

By “at least one” it is herein preferably understood 1, 2, 3, 4 or 5, more preferably 1, 2, 3 or 4, more preferably 1, 2 or 3, and even more preferably 1 or 2.

The pasteurization may allow decreasing the loss of vitamin D during shelf life.

By “pasteurizing” or “pasteurization” it is herein preferably understood a process in which the mixture of fat phase and stabilizer dispersion preferably hydrocolloid dispersion is heated at a temperature comprised between 60° C. and 130° C., preferably between 70° C. and 120° C., more preferably between 80° C. and 110° C., for time preferably comprised between 5 seconds and 30 min, more preferably between 10 seconds and 20 minutes, and even more preferably between 15 seconds and 5 minutes.

The process may also include a step of aseptic filing the emulsion in a container.

The process may further comprise a step of diluting the mixture of fat phase and stabilizer dispersion preferably hydrocolloid dispersion to obtain a beverage.

A fourth object of the present invention relates to the use of the beverage comprising said emulsion as previously defined, as a functional beverage.

By «functional beverage», it is herein preferably understood a non-alcoholic drinks providing health benefits beyond their nutritional value, positively affecting or functional focusing on the body or mind to promote the state of health and well-being. Preferably, the functional beverage is functional water.

The invention is further described with reference to the following examples. It will be appreciated that the invention as claimed is not intended to be limited in any way by these examples.

### EXAMPLES

### Example 1: Preparation of the Emulsion

### 1. Material & Methods

a. Raw Material

TABLE 1
Characteristics of ingredients for preparing emulsion

| | Commercial | | |
|---|---|---|---|
| Usual name | name/composition | Appearance | Supplier |
| Vitamin D | Vitamin D3 1.0 MIU/g | Oily liquid | DSM |
| | | | (Basel |
| | | | Switzerland) |
| Monoglyc- | Dimodan MO 90/D Kosher | Oily solid | Danisco |
| eride | Distilled mono-unsatured | | (Denmark) |
| | monoglyceride made from | | |
| | sunflower oil containing | | |
| | about 96 wt % | | |
| | monoglycerides | | |
| Triglyceride | Radiamuls MCT 2105K | Oily liquid | Sofinol |
| | Medium Chain | | (Switzerland) |
| | Triglyceride | | |
| | 60% C8:0 (caprylic acid), | | |
| | 40% C10:0 (capric acid) | | |
| Oat oil | Sweoat Oil PL40 FG | Oily liquid | Swedish Oat |
| | | | Fiber |
| Hydrocolloid | Eficacia XE Nexira | Powder | Nexira Food |
| | Natural product (100% | | (CNI Rouen, |
| | acacia gum) designed for | | France) |
| | emulsion applications. | | |
| | GMO free. | | |
| Citric acid | Citric acid anhydrous | Powder | Jungbunzlauer |
| | 100% | | (Germany) |

b. Commercial Beverage Used
Vittel Grande Source water commercialized by Nestlé.

### 2. Method

Sample 2 (listed in Table 2) has been prepared according to the following method.

Firstly, the aqueous phase was prepared by heating Vittel Grande Source water to 60° C. A magnetic stirrer was then used to disperse 2,9% by weight of hydrocolloid (Eficacia XE Nexira—acacia gum) into water at 300 rpm thereby providing the aqueous phase. Secondly, the fat phase was prepared by mixing 0.29% by weight of triglyceride (Radialmus MCT 2105 K) with 0.2% by weight of monoglyceride (Dimodan MO 90/D Kosher), both heated to 60° C., until the complete dispersion of monoglyceride and obtaining of a homogeneous fat phase. Then, the vitamin D was added to the fat phase and the fat phase was kept at 60° C. The aqueous and fat phases were stirred by Polytron (rotor-stator system by Silverson Machines Ltd, England) at 6000 rpm for 2 minutes to form a coarse emulsion which was further homogenized using the high-pressure homogenizer Niro Pandaplus 2000 (GEA Mechanical Equipment, Italia) at 250±50 bars. At the end of the homogenization process, the acid citric was added to the emulsion to reach a pH of 3.5. Pasteurization is realized at 94° C. for 23 seconds in an oven with steam (GEA, SAP Italia) to ensure microbiological safety of emulsion.

The other formulations listed in Table 2 have been prepared according to the same method. Regarding sample 4, oat oil is added with triglycerides. The percentages are percentages by weight with respect to the total weight of the emulsion.

TABLE 2
Different formulations of emulsion

| | Vitamin D | Triglyceride | Hydrocolloid | | Oat oil | Citric acid | Water |
|---|---|---|---|---|---|---|---|
| | (% by | (% by | (% by | Monoglyceride | (% by | (% by | (% by |
| Sample | weight) | weight) | weight) | (% by weight) | weight) | weight) | weight) |
| 1 | 0.0002025 | 0.49 | 2.9 | — | — | 0.2 | 96.4097975 |
| 2 | 0.0002025 | 0.29 | 2.9 | 0.2 | — | 0.2 | 96.4097975 |
| 3 | 0.0002025 | 0.06 | 2.9 | 0.04 | — | 0.2 | 96.7997975 |
| 4 | 0.0002025 | 0.375 | 2.9 | — | 0.125 | 0.2 | 96.3997975 |

### 3. Physical Stability Analysis

### Particle Size (Average Oil Droplet Size)

Particle size was measured in the emulsion using Dynamic light scattering instrument with a NanoLab 3D (LS Instruments, Fribourg, Switzerland). All measurements were performed at 20° C. and in triplicates at a scattering angle of 90° and viscosity was determined using a rotational test with a conical geometry and the Physica MCR 501 rheometer from Anton Paar was used (Graz, Austria).

### Viscosity Analysis

Viscosity measurements were performed at 20° C. with the Physica MCR 501 rheometer from Anton Paar. A conical geometry was used and 20 mL of each sample were introduced into the receptacle. Viscosity measurements of the different water phases used to produce emulsions were mandatory for DLS analysis. Indeed, the solvent's viscosity is required (as the RI-Refractive Index) to measure the size distribution of droplets (knowledge of the solvent's viscosity and RI is necessary for this method to obtain the hydrodynamic diameter). Moreover, viscosity analysis confirms the Newtonian behavior of emulsions.

### Dynamic Light Scattering

Dynamic light scattering (DLS) technique is used for rapidly determining the size distribution of small particles or droplets in suspensions in the range from 0.15 nm to 5 μm with NanoLab 3D (LS Instruments, 2020). Due to Brownian motion of small particles, the change of relative spatial location will induce the intensity fluctuation. DLS is based on recording intensity fluctuations when light is scattered by particles. The statistics of these fluctuations are reflected in the correlation function. DLS can extract the particle size distribution from the obtained correlation function. The NanoLab 3D is patented Modulated 3D Cross-Correlation technology and it allows the suppression of the influence of multiple scattering in the signal due to turbid samples. Sample dilution is no longer required with this instrument. All measurements were performed at 20° C. and in triplicates at a scattering angle of 90°.

### 4. Quantification of Vitamin D3

### Determination of Concentration of Vitamin D3

TABLE 3
UV parameters for spectrophotometric
determination of concentration

| | ∧max | | Aliquot | | Dilution |
|---|---|---|---|---|---|
| Compound | [nm] | E_{1 cm}^{1%} | [μL] | Solvent | factor |
| Cholecalciferol | 265 | 480 | 200 | EtOH | 50 |

The absorbance was measured (A_{λmax}) at the maximum absorbance wavelength (max) and according to the following formula the concentration was determined.

$$Concentration ( μg / mL ) = \frac{ABSstd \times D \times 1000}{E 1 cm 1 \%}$$

ABS_{std}=Absorbance measured at λmax [nm]
E_{1 cm}^{1%}=Mass extinction coefficient (theorical absorbance of a 1% solution)
D=Dilution factor (volume of aliquot/final volume)
10000=Conversion factor to express the final result in μg/mL

Sample's preparation was done by saponification and liquid-liquid extraction. 200 μL of standard is added before saponification and the residue after evaporation is resolved in 2 mL of hexane. The method applied is Liquid Chromatography (LC) with detection by spectrophotometry, it is commonly used in the analysis of fat-soluble vitamins.

The uncertainty associated with the measurement method is approximately equal to ±9%.

### 5. Results

Results are presented in Tables 4, 5 and 6 below.

TABLE 4
Average oil droplet size for the different samples.
Values represent the average hydrodynamic diameter
using “Corenn” volume calculation in the software
of the NanoLab 3D (LS Instruments, Fribourg, Switzerland).

| | Lipid content (Triglyceride | |
|---|---|---|
| | and optionally monoglyceride | Average oil |
| | or optionally oat oil) | droplet size |
| Sample | (% by weight) | (nanometer) |
| 1 | 0.49% | 290 nm |
| 2 | 0.49% | 290 nm |
| 3 | 0.1% | 225 nm |
| 4 | 0.5% | — |

TABLE 5
Extended shelf life (20° C., light) for sample 2

| Time in | Vitamin D in |
|---|---|
| months | μg/L |
| 0 | 121 |
| 3 | 122 |
| 6 | 116 |

TABLE 6
Accelerated shelf life (40° C., dark) for sample 2

| Time in | Vitamin D in |
|---|---|
| months | μg/L |
| 0 | 121 |
| 0.5 | 110 |
| 1 | 111 |

### CONCLUSION

The results for samples 1, 2, 3 and 4, which contain vitamin D, a triglyceride, a hydrocolloid and optionally a monoglyceride or optionally oat oil and with a lipid content (triglyceride and optionally monoglyceride or oat oil) within the claimed range have a good stability.

The lipid content has thus an impact on the emulsion stability. In particular, the lipid content within the claimed range enables to prevent vitamin D from chemical degradation (less vitamin D loss) and to obtain a particle size (diameter) comprised between 200 nm and 300 nm thereby avoiding the aggregation phenomenon and thus providing a stable emulsion.

1. An emulsion comprising:
between 0.0000002% and 0.1% by weight of vitamin D or its derivatives with respect to the total weight of emulsion,
between 0.0001% and 10% by weight of triglyceride with respect to the total weight of emulsion, and
between 0.01% to 50% by weight of hydrocolloid with respect to the total weight of emulsion.

2. The emulsion according to claim 1, wherein the triglyceride is a medium chain triglyceride.

3. The emulsion according to claim 1, wherein the hydrocolloid is selected from the group consisting of polysaccharides including acacia gum, xanthan gum, gelatin, carrageenan gum, gellan gum, karaya gum, larch gum, dextran, chitosan, alginate, hyaluronic acid, guar gum, pectin, cellulose, tara gum, tamarind gum, ghatti gum, curdlan gum, konjac glucomannan, scleroglucan, pullulan, agar, tragacanth gum, Portulaca oleracea gum, galactomannan, pectin, starch or modified starch, cellulose derivative and mixtures thereof.

4. The emulsion according to claim 1, wherein said emulsion further comprises a monoglyceride or its derivatives.

5. The emulsion according to claim 4, wherein the monoglyceride is an unsaturated monoglyceride.

6. The emulsion according to claim 4, wherein said emulsion comprises between 0.0001% and 3% by weight of monoglyceride or its derivatives with respect to the total weight of emulsion.

7. The emulsion according to claim 1, wherein the ratio between the total amount of hydrocolloid and the total amount of vitamin D or its derivatives in the emulsion (hydrocolloid/vitamin D) is between 5 and 1 000 000.

8. The emulsion according to claim 1, wherein the ratio between total amount of triglyceride and the total amount vitamin D or its derivatives in the emulsion is between 150 and 100 000.

9. The emulsion according to claim 1, wherein the ratio between the total amount of triglyceride and the total amount of vitamin D or its derivatives in the emulsion is between 900 and 10 000.

10. The emulsion according to claim 1, wherein the ratio between the total amount of hydrocolloid and the total amount of triglyceride is between 1 and 100.

11. The emulsion according to claim 1, wherein the ratio between the total amount of triglyceride and the total amount of monoglyceride or its derivatives in the emulsion is between 0.5 and 100.

12. The emulsion according to claim 11, wherein the emulsion is an oil-in-water emulsion and comprises dispersed oil droplets having an average oil droplet size in the range comprised between 50 nm and 3 000 nm.

13. (canceled)

14. A process for preparing an emulsion comprising:
a step of mixing triglyceride and vitamin D or its derivatives, thereby providing a fat phase,
a step of dispersing the stabilizer preferably the hydrocolloid in water, thereby providing a stabilizer dispersion preferably a hydrocolloid dispersion, and
a step of mixing the fat phase and stabilizer dispersion preferably hydrocolloid dispersion, thereby providing a mixture of fat phase and stabilizer dispersion.

15. A process for preparing a beverage as defined in claim 14, wherein said process comprises:
a step of mixing triglyceride and vitamin D or its derivatives, thereby providing a fat phase,
a step of dispersing the stabilizer preferably the hydrocolloid in water, thereby providing a stabilizer dispersion preferably a hydrocolloid dispersion,
a step of mixing the fat phase and stabilizer dispersion preferably hydrocolloid dispersion, thereby providing a mixture of fat phase and stabilizer dispersion preferably hydrocolloid dispersion, and
a step of diluting the mixture of fat phase and stabilizer dispersion preferably hydrocolloid dispersion to obtain a beverage.
